(19) United States
(12) Patent Application Publication
(10) Pub. No.: US 2013/0196049 A1
(43) Pub. Date: Aug. 1, 2013

(54) REDUCED SODIUM SALT

(71) Applicants: Douglas Hugh Brown, East Kilbride (GB); Michael Klinge, East Kilbride (GB); Stephan Klinge, East Kilbride (GB)

(72) Inventors: Douglas Hugh Brown, East Kilbride (GB); Michael Klinge, East Kilbride (GB); Stephan Klinge, East Kilbride (GB)

(73) Assignee: KLINGE CHEMICALS LTD., East Kilbride (GB)

(21) Appl. No.: 13/635,750

(22) PCT Filed: Apr. 14, 2010
(86) PCT No.: PCT/GB10/50614

§ 371 Date: Nov. 29, 2012

(30) Foreign Application Priority Data
Apr. 14, 2009 (GB) 0906379.3

(51) Int. Cl. A23L 1/304

(52) U.S. Cl. CPC A23L 1/3045
USPC 426/649; 426/520; 426/515; 426/518; 426/479; 426/519

(57) ABSTRACT

There is provided a process for preparing a reduced sodium salt composition, the process comprising the steps of mixing sodium chloride with one or more sodium chloride substitute complexes, heating the so-formed mixture to form a melt, and cooling the melt to form a solid. The so-formed solid is a fused granular matrix of sodium chloride and one or more sodium chloride substitute complexes. An alternative process is provided in which the sodium chloride and the sodium chloride substitute complex are heated to the liquid phase before they are combined. A reduced sodium salt composition is also provided, in particular a reduced sodium chloride salt obtained from these processes.

### FIELD OF INVENTION

The present invention relates to reduced sodium salt. In particular, the present invention relates to an improved reduced sodium salt in the form of a composition that can be ground using, for example, a conventional salt mill.

### BACKGROUND OF THE INVENTION

Sodium chloride, commonly referred to as “salt”, is an important part of our diet, and is derived from many sources. Around 40% of salt by weight is sodium; an ion that plays an important physiological role. In particular, sodium and potassium ions are both required for the maintenance of extracellular fluid volume (which influences blood pressure), for the generation and transmission of electrical impulses in nerves and muscles, and for the uptake of nutrients from the small intestine. Insufficient sodium in the diet can therefore prevent the body from functioning properly.

Most dietary sodium (around 60-70%) is added to foodstuffs during cooking or in food manufacture and processing. A lesser amount (around 10%) is inherent in certain foods such as eggs and fish. The vast majority (around 10-20%) of the remaining dietary sodium is discretionary, being added by an individual in the form of salt prior to consumption of foodstuffs.

There are various recommendations regarding sodium consumption ranging from around 600 mg/day to around 3.5 g/day—the UK Reference Nutrient Intake for adults being 1.6 g sodium/day (equivalent to around 4.2 g salt/day). However, studies suggest that average sodium intake for adults in the UK is far higher than this recommended figure, being about 4 g sodium/day (around 10.1 g salt/day) for men, and about 3 g sodium/day for women (around 7.7 g salt/day). This excess of sodium in the diet has been linked to physiological problems such as hypertension, gastric cancer and osteoporosis. Therefore, there is a general consensus that reducing sodium intake is beneficial to health.

Reduced sodium salts, which contain a mixture of sodium chloride and other complexes such as potassium chloride, have been known for several years. As reduced sodium salts contain less sodium per gram than traditional salt, their use results in less consumption of sodium. There are a number of reduced sodium salt products available, and these generally consist of a blend of sodium chloride with potassium chloride. Alternative versions consist of sodium chloride with potassium chloride and other complexes such as magnesium complexes or mixtures of amino acids. These products are simply blends of the individual components mechanically blended together.

Over the last few years, the salt industry has introduced discretionary salt in the form of sea and rock salt, marketing these as being a natural and healthy alternative to processed granular salt. Sea and rock salts are often in the form of crystalline particles of a suitable size to be ground in a hand held salt mill. Sea and rock salts are considered an up-market alternative to regular processed granular salt. An important part of the user experience is the satisfying “crunch” that is produced when these salts are milled. Also, the organoleptic properties of these salts is of importance. For example, the coarse texture of the salt crystals in the mouth is desirable.

Whilst sea and rock salts are considered a healthier and more sophisticated alternative to regular processed granular salt, they do not contain reduced levels of sodium. Moreover, reduced sodium salt has not been produced in a form that is suitable for grinding in hand held salt mills. This is largely because, unlike sodium chloride, potassium chloride and magnesium complexes do not form suitably sized crystals with sufficient hardness to be ground in a hand held salt mill. Rather, these complexes tend to form small granular particles which are too small to grind. When larger granules are formed, they are easily crushed using minimum force (such as when squeezed between the fingers), and thus are too fragile for mass processing and transportation, and are unsuitable for use in hand held salt mills. In addition, due to their fragility, when ground such granules do not produce a “crunch”, which forms an important part of the user experience. Therefore, simply mixing potassium chloride and sodium chloride crystals does not provide a satisfactory product. Furthermore, such a mixed product tends to separate out into the individual salts thus providing an inhomogeneous mix. For example, a mixture of relatively large potassium chloride and sodium chloride crystals will tend to separate into the component salts during production, packaging or transport.

Therefore, it is an object of the present invention to overcome at least some of the drawbacks associated with the prior art.

A further object of the invention is to provide a reduced sodium salt suitable for use with hand held salt mills.

### DESCRIPTION OF THE INVENTION

The invention to be more particularly described hereinafter provides a reduced sodium salt, suitable for use with a hand held salt mill, by selection of a novel production process, and by preparation of a novel composition. The process provides a composition in the form of reduced sodium salt particles that are of sufficient hardness to be mass produced and transported, and that are of suitable size and sufficient hardness to be ground in a hand held salt mill. In addition, the reduced sodium salt of the present invention provides an audible and tactile “crunch” when ground, thus enhancing the user experience. Also, the process of the present invention ensures homogeneity of the product is maintained from the start of the production process, through processing, packaging and transportation, and to the final product as used by the consumer. Homogeneity provides consistency of taste and meets nutritional claims.

According to a first aspect of the invention there is provided a process for preparing a reduced sodium salt composition, the process comprising the steps of: mixing sodium chloride with one or more sodium chloride substitute complexes; heating the so-formed mixture from the solid phase to the liquid phase to form a mixed melt; cooling the mixed melt from the liquid phase to the solid phase to form a solid.

The so-formed mixture may be substantially homogeneous. The so-formed solid may be substantially homogeneous.

The so-formed solid may be a fused granular matrix of sodium chloride and one or more sodium chloride substitute complexes.

The process of solidification may involve a casting step.

The process may comprise the further step of dispensing the mixed melt into a cast. This step may be carried out after mixing and melting, and before cooling.

The process may comprise the further step of crushing the so-formed solid to form fused granular matrix particles of a desired particle size.

In one embodiment the particles have a longest dimension of about 1 mm to about 5 mm.

The process may comprise the further step of sieving the so-formed particles to isolate a particular range of particle sizes.

The one or more sodium chloride substitute complex may be a potassium complex, and in particular may be potassium chloride. Alternatively the sodium chloride substitute complex may be a mixture of a potassium complex and a magnesium complex, and may in particular be a mixture of potassium chloride and magnesium chloride.

The mixture may be heated from about 770° C. to about 1500° C., typically from about 770° C. to about 980° C., most typically from about 820° C. to about 920° C., and in particular from about 850° C. to about 870° C. If the process is conducted at too high a temperature, the salts are burned or are lost to the air resulting in a lower yield of product. However, the process will not provide a homogeneous material on a reasonable timescale if the temperature is too low.

The mixture is heated for sufficient time to obtain a molten state and may be heated for about 60 minutes. The duration of heating will, of course, depend on the amount of product being handled.

The process may comprise the further step of mixing the mixed melt. In one embodiment mixing of the mixed melt is achieved by vortexing, or applying a vortex to, the mixed melt. Vortexing may be achieved, for example, by using a conventional mixer or stirrer mechanism.

According to a second aspect of the present invention there is provided a process for preparing a reduced sodium salt composition, the process comprising the steps of: heating sodium chloride and one or more sodium chloride substitute complexes to the liquid phase; mixing the molten sodium chloride with the one or more molten sodium chloride substitute complexes to form a mixed melt; cooling the mixed melt from the liquid phase to the solid phase to form a solid.

The so-formed mixed melt may be substantially homogeneous. The so-formed solid may be substantially homogeneous.

The so-formed solid may be a fused granular matrix of sodium chloride and one or more sodium chloride substitute complexes.

The process of solidification may involve a casting step.

The process may comprise the further step of dispensing the mixed melt into a cast. This step may be carried out after mixing and melting, and before cooling.

The process may comprise the further step of crushing the so-formed solid to form fused granular matrix particles of a desired particle size.

In one embodiment the particles have a longest dimension of about 1 mm to about 5 mm.

The process may comprise the further step of sieving the so-formed particles to isolate a particular range of particle sizes.

The one or more sodium chloride substitute complex may be a potassium complex, and in particular may be potassium chloride. Alternatively the sodium chloride substitute complex may be a mixture of a potassium complex and a magnesium complex, and may in particular be a mixture of potassium chloride and magnesium chloride.

The mixed melt may be heated from about 770° C. to about 1500° C., typically from about 770° C. to about 980° C., most typically from about 820° C. to about 920° C., and in particular from about 850° C. to about 870° C. If the process is conducted at too high a temperature, the salts are burned or are lost to the air resulting in a lower yield of product. However, the process will not provide a homogeneous material on a reasonable timescale if the temperature is too low.

The mixed melt is heated for sufficient time to obtain a molten state and may be heated for about 60 minutes. The duration of heating will, of course, depend on the amount of product being handled.

The process may comprise the further step of mixing the mixed melt. In one embodiment mixing of the mixed melt is achieved by vortexing, or applying a vortex to, the mixed melt. Vortexing may be achieved, for example, by using a conventional mixer or stirrer mechanism.

According to a third aspect of the present invention there is provided a composition obtained according to the process of the first aspect or the second aspect.

According to a fourth aspect of the present invention there is provided a composition comprising granules of sodium chloride and granules of one or more sodium chloride substitute complexes, wherein the granules are fused together to form a fused granular matrix.

The fused granular matrix may be in the form of particles.

The fused granular matrix particles may have a longest dimension of about 1 mm to about 5 mm.

The granules are fused with sufficient strength to provide hard particles of mixed-complex reduced sodium salt.

The one or more sodium chloride substitute complexes may be a potassium complex and in particular may be potassium chloride. Alternatively the sodium chloride substitute complex may be a mixture of a potassium complex and a magnesium complex, and may in particular be a mixture of potassium chloride and magnesium chloride.

The present invention will now be described by way of example only.

### Example 1

A reduced sodium salt composition with 66.7% sodium reduction was prepared using the following process.

To make 100 g of reduced sodium salt, 66.7 g of solid granular potassium chloride and 33.3 g of solid granular sodium chloride were added to a mechanical mixer. The mechanical mixer was operated in a manner intended to break up any clumps present in the granular solids, and to form an intimate mix of the two complexes. The solid mixture was then transferred to a crucible and the crucible was placed in a furnace. The mixture was then heated to approximately 850° C. for approximately 60 minutes such that it became molten. The so-formed melt was then formed by casting into mild steel formers at room temperature, where it was allowed to cool such that the mixture solidified. The ingots of solidified mixture were then mechanically broken using a standard jaw-crusher to achieve the desired particle size of between about 1 mm and about 5 mm. The crushed product was then passed through a number of sieves to ensure the correct size of particle. The content of the composition produced was validated using atomic absorption techniques, as illustrated in Table 1 below. This shows that the composition is a homogeneous fused granular matrix, rather than fused clumps of sodium chloride and potassium chloride. The total amounts of potassium and sodium are as expected for a homogeneous matrix. Whilst the sodium assay has an error of around 6%, this is acceptable for what is a difficult assay.

TABLE 1

| | % w/w Potassium | | | % w/w Sodium | | |
|---|---|---|---|---|---|---|
| Sample | | Average | Average | | Average | Average |
| 1 | 35.33 | 35.35 | 34.97 | 13.02 | 12.44 | 12.22 |
| 2 | 35.36 | | | 12.19 | | |
| 3 | 35.35 | | | 12.12 | | |
| 4 | 34.60 | 34.71 | | 12.02 | 12.07 | |
| 5 | 34.16 | | | 11.96 | | |
| 6 | 35.38 | | | 12.24 | | |
| 7 | 34.11 | 34.85 | | 12.09 | 12.15 | |
| 8 | 34.94 | | | 12.37 | | |
| 9 | 35.50 | | | 11.98 | | |

| | |
|---|---|
| Potassium target = 34.97% | Sodium target = 13.11% |

In this particular example, a temperature of 850° C. for 60 minutes is sufficient to completely melt the mixture with minimal fume, thereby ensuring that the yield of final product remains high. This also ensured that no particular constituent was lost, and that the starting and finishing Na:K ratios remained substantially constant. However, it is clear that the process can be carried out at any reasonable and practical temperature and timescale that provides a molten material. For example, a molten state may be achieved in the above example using a temperature of between about 770° C. and about 1500° C. The process is, however, typically carried out at a temperature of 770° C. to 980° C. above which temperature the salts tend to burn and be lost to air. In some examples the temperature is between 820° C. and 920° C., and in particular between 850° C. and 870° C. Varying the relative amounts of sodium chloride and potassium chloride, and using alternative complexes in place of potassium chloride (such as magnesium chloride), will also impact the range of, and optimum, temperatures and timescales at which to carry out the process.

Further, whilst in the above example the potassium chloride and sodium chloride were mixed as solids, it is clear that in the alternative two complexes could be heated independently to a molten state, before being combined and mixed to obtain an intimate liquid mix by convection. Also, the method of mixing may be by way of conventional stirring, or can involve the use of static mixers and fluid flow paths as is known in the art of mixing and process technology.

Whilst in the example given the casting is carried out using mild steel ingots, other casting equipment known in the art may be used. Similarly, the cooling process takes place at room temperature, but may also be carried out at elevated or reduced temperatures to obtain the desired fused structure.

### Example 2

Further compositions were prepared in accordance with the examples in Table 2.

TABLE 2

| KCl (g) | K content (g) | NaCl (g) | Na content (g) | Na Reduction |
|---|---|---|---|---|
| 1 | 0.524 | 99 | 38.943 | 1% |
| 5 | 2.622 | 95 | 37.370 | 5% |
| 10 | 5.244 | 90 | 35.403 | 10% |
| 15 | 7.867 | 85 | 33.436 | 15% |
| 20 | 10.489 | 80 | 31.469 | 20% |
| 25 | 13.111 | 75 | 29.502 | 25% |
| 30 | 15.733 | 70 | 27.536 | 30% |
| 35 | 18.356 | 65 | 25.569 | 35% |
| 40 | 20.978 | 60 | 23.602 | 40% |
| 45 | 23.600 | 55 | 21.635 | 45% |
| 50 | 26.222 | 50 | 19.668 | 50% |
| 55 | 28.845 | 45 | 17.701 | 55% |
| 60 | 31.467 | 40 | 15.735 | 60% |
| 65 | 34.089 | 35 | 13.768 | 65% |
| 66 | 34.614 | 34 | 13.375 | 67% |
| 67 | 35.138 | 33 | 12.981 | 67% |
| 70 | 36.711 | 30 | 11.801 | 70% |
| 75 | 39.334 | 25 | 9.834 | 75% |
| 80 | 41.956 | 20 | 7.867 | 80% |
| 85 | 44.578 | 15 | 5.900 | 85% |
| 90 | 47.200 | 10 | 3.934 | 90% |
| 95 | 49.823 | 5 | 1.967 | 95% |
| 99 | 51.920 | 1 | 0.393 | 99% |

The composition produced is a substantially homogeneous fused granular matrix of potassium chloride and sodium chloride. The matrix is fused intimately and firmly enough to provide relatively “hard” particles of composition. This “hardness” enables the so-formed particles of composition to be ground in a hand held salt mill. In addition, the particles are hard enough to be mass produced and transported without disintegrating into their granular components. Also, the starting and finishing Na:K ratios remain substantially constant.

### Example 3

A reduced sodium salt composition with 66.7% sodium reduction was prepared using the following process.

To make 1500 kgs of reduced sodium salt, 1000.5 kgs of solid granular potassium chloride and 499.5 kgs of solid granular sodium chloride were blended in a mechanical mixer in 42 kg batches. The mechanical mixer was operated in a manner intended to break-up any clumps present in the granular solids, and to form an intimate mix of the two complexes. The solid mixture in smaller lot sizes was then transferred to a crucible design gas-fired furnace. The mixture was then heated to approximately 870° C. for approximately 3 hours such that it became molten. Whilst heating, a vortex was created within the furnace ensuring that the molten salts were intimately mixed at all times. The so formed melt was then poured into a chill table, which was cooled using water. The molten salt was left to solidify on the chill table thereby forming a solid mixture. The solid mixture was then mechanically broken using a standard “Retsch” (trademark) jaw crusher to achieve the desired particle size of between about 1 mm and 5 mm. The crushed product was then passed through a number of sieves to ensure the correct size of particles. The content of the composition produced was validated using atomic absorption techniques as illustrated in Table 3 below. These are examples from three different 1.5 tonne batches where sampling of individual lots is taken on an ongoing basis. This shows that the composition is a homogeneous fused granular matrix, rather than fused clumps of sodium chloride and potassium chloride. The total amounts of potassium and sodium are as expected for a homogeneous matrix.

TABLE 3

| | | % w/w Potassium | | | % w/w Sodium | | |
|---|---|---|---|---|---|---|---|
| Batch No. | Lot No. | | Average | Average | | Average | Average |
| LS020709 | 19 | 35.43 | 35.73 | 34.24 | 12.38 | 12.42 | 12.44 |
| | 21 | 36.02 | | | 12.46 | | |
| LS261009 | 9 | 34.19 | 34.52 | | 12.40 | 12.51 | |
| | 35 | 34.93 | | | 12.64 | | |
| | 52 | 34.43 | | | 12.49 | | |
| LS310709 | 4 | 32.64 | 32.48 | | 12.26 | 12.40 | |
| | 5 | 32.40 | | | 12.33 | | |
| | 6 | 32.28 | | | 12.61 | | |
| | 7 | 32.48 | | | 12.24 | | |
| | 8 | 32.71 | | | 12.28 | | |
| | 17 | 31.86 | | | 12.04 | | |
| | 21 | 33.96 | | | 13.04 | | |

| | |
|---|---|
| Potassium target = | Sodium target = |
| 34.63% ± 3.50 | 13.11% ± 1.31 |

In an alternative embodiment, a reduced sodium salt composition was prepared as described in Examples 1, 2 or 3 using magnesium chloride as a replacement for some of the potassium chloride. The quantities used were recalculated to account for the different weights of magnesium chloride and potassium chloride, and the temperature of the process was adjusted to take into account the different melting point. The process provided a reduced sodium salt having a fused granular matrix of sodium chloride, potassium chloride and magnesium chloride.

It will be appreciated that the process described is suitable for producing reduced sodium salts using other sodium chloride substitute complexes such as magnesium complexes and potassium complexes. Of course, more than one of these complexes may be incorporated into the finished product.

In the examples given, the complexes are heated using a furnace. It will be understood that a melt can also be achieved using alternative suitable techniques known in the art, such as by using direct or indirect heating, induction or microwave radiation.

It has surprisingly been found that by mixing sodium chloride with one or more sodium chloride substitute complexes, and by melting and then solidifying the so-formed mixture, a fused granular matrix reduced sodium salt is obtained. Particles of fused granular matrix reduced sodium salt can then be produced by crushing and sieving the so-formed solid. The particles are of sufficient hardness to be mass produced and transported, and are of suitable size and sufficient hardness to be ground in a hand held salt mill. In addition, the reduced sodium salt of the present invention provides an audible and tactile “crunch” when ground and an appealing and satisfying coarse texture in the mouth, thus enhancing the user experience. The product also has the same taste profile as regular low sodium salts, and does not have the bitter taste sometimes associated with potassium chloride.

Various modifications and variations to the described embodiments of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the art are intended to be covered by the present invention.

1. A process for preparing a reduced sodium salt composition, the process comprising the steps of: mixing sodium chloride with one or more sodium chloride substitute complexes; heating the so-formed mixture from the solid phase to the liquid phase to form a mixed melt; cooling the mixed melt from the liquid phase to the solid phase to form a solid.

2. The process of claim 1 wherein the process of solidification comprises a casting step.

3. The process of claim 1 comprising the further step of dispensing the mixed melt into a cast.

4. The process of claim 1 comprising the further step of crushing the so-formed solid to form a desired particle size.

5. The process of claim 4 comprising the further step of sieving the particles to isolate a particular range of particle sizes.

6. The process of claim 4 wherein the particle size is from about 1 mm to about 5 mm.

7. The process of claim 1 wherein the mixed melt is substantially homogeneous.

8. The process of claim 1 wherein the so-formed solid is substantially homogeneous.

9. The process of claim 1 wherein the so-formed solid is a fused granular matrix of sodium chloride and one or more sodium chloride substitute complexes.

10. The process of claim 1 wherein the sodium chloride substitute complex is a potassium complex.

11. The process of claim 1 wherein the sodium chloride substitute complex is a mixture of a potassium complex and a magnesium complex.

12. The process of claim 1 wherein the mixture is heated to between about 770° C. and about 980° C.

13. The process of claim 1 wherein the mixture is heated to between about 820° C. and about 920° C.

14. The process of claim 1 wherein the mixture is heated to between about 850° C. and about 870° C.

15. The process of claim 1 wherein the mixture is heated for sufficient time to obtain a molten state.

16. The process of claim 1 comprising the further step of mixing the mixed melt.

17. The process of claim 16 wherein the mixing is achieved by applying a vortex to the mixed melt.

18. A process for preparing a reduced sodium salt composition, the process comprising the steps of: heating sodium chloride and one or more sodium chloride substitute complexes to the liquid phase; mixing the molten sodium chloride with the one or more molten sodium chloride substitute complexes to form a mixed melt; cooling the mixed melt from the liquid phase to the solid phase to form a solid.

19. The process of claim 18 wherein the process of solidification comprises a casting step.

20. The process of claim 18 comprising the further step of dispensing the mixed melt into a cast.

21. The process of claim 18 comprising the further step of crushing the so-formed solid to form a desired particle size.

22. The process of claim 21 comprising the further step of sieving the particles to isolate a particular range of particle sizes.

23. The process of claim 21 wherein the particle size is from about 1 mm to about 5 mm.

24. The process of claim 18 wherein the mixed melt is substantially homogeneous.

25. The process of claim 18 wherein the so-formed solid is substantially homogeneous.

26. The process of claim 18 wherein the so-formed solid is a fused granular matrix of sodium chloride and one or more sodium chloride substitute complexes.

27. The process of claim 18 wherein the sodium chloride substitute complex is a potassium complex.

28. The process of claim 18 wherein the sodium chloride substitute complex is a mixture of a potassium complex and a magnesium complex.

29. The process of claim 18 wherein the mixed melt is heated to between about 770° C. and about 980° C.

30. The process of claim 18 wherein the mixed melt is heated to between about 820° C. and about 920° C.

31. The process of claim 18 wherein the mixed melt is heated to between about 850° C. and about 870° C.

32. The process of claim 18 comprising the further step of mixing the mixed melt.

33. The process of claim 32 wherein the mixing is achieved by applying a vortex to the mixed melt.

34. A composition obtained according to the process of any one of claims 1 to 17, or the process of claim 18.

35. A composition comprising granules of sodium chloride and granules of one or more sodium chloride substitute complexes, wherein the granules are fused together to form a fused granular matrix.

36. The composition as claimed in claim 35 comprising particles of the fused granular matrix, said particles having a longest dimension of from about 1 mm to about 5 mm.

37. The composition as claimed in claim 35 wherein the sodium chloride substitute complex is a potassium complex.

38. The composition as claimed in claim 35 wherein the sodium chloride substitute complex is a mixture of a potassium complex and a magnesium complex.
